(19) United States
(12) Patent Application Publication
(10) Pub. No.: US 2004/0160566 A1
(43) Pub. Date: Aug. 19, 2004

(54) Liquid crystal display panel with fluid control wall

(76) Inventors: Shinichi Kawabe, Yokohama (JP); Hideyuki Honoki, Yokohama (JP); Hitoshi Azuma, Yokohama (JP); Yoshihiro Arai, Mobara (JP); Setsuo Kobayashi, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/641,024

(22) Filed: Aug. 15, 2003

(30) Foreign Application Priority Data
Feb. 17, 2003 (JP) 2003-037747

(51) Int. Cl. G02F 1/1339

(52) U.S. Cl. 349/153

(57) ABSTRACT

A substrate includes fluid control walls for controlling the liquid crystal fluid closer to the liquid crystal dropped spot of a display area or frame-like fluid control walls between a sealing material and the display area. After the liquid crystal is dropped on the display area, a pair of substrates are pasted and then picked out in the atmosphere for applying pressure onto the pair of substrates and diffusing the liquid crystal. The liquid crystal fluid control walls serve to control the liquid crystal fluid, thereby suppressing the liquid crystal contamination caused by the contact of the unhardened sealing material with the liquid crystal and the relevant display failure.

### BACKGROUND OF THE INVENTION

The present invention relates to a liquid crystal display panel which is manufactured using the liquid crystal drop fill method.

As a thin, lightweight, and low-consumption display device, a liquid crystal display device becomes increasingly popular. The liquid crystal display device is arranged to build a driving circuit and the relevant circuits to a tabular device called a liquid crystal display panel. FIG. 1 is a sectional model view for explaining a schematic structure of one liquid crystal display panel (often referred simply to as a display panel throughout the specification). As shown in FIG. 1, the liquid crystal display panel 9 is structured to have a pair of lapped substrates and a liquid crystal 5 laid therebetween, the pair of lapped substrates being composed of a thin film transistor (simply called a TFT) substrate (also called a TFT substrate) 1a and the other color filter substrate 1b (also called a CF substrate), the latter substrate composing three color filters of red (R), green (G), and blue (B) at a normal mode. Further, between the pair of substrates 1a and 1b is located spacers 4 for regulating a gap between both of the substrates. A sealing material 7 is filled in a sealing portion on the periphery of the pair of substrates 1a and 1b, for pasting the substrates 1a and 1b. The heretofore proposed method of manufacturing the liquid crystal panel 9 is roughly divided into the liquid crystal injecting method and the liquid crystal drop fill method.

The liquid crystal injecting method is the method of lapping the TFT substrate 1a and the CF substrate 1b one over the other, pasting these substrates 1a and 1b, and injecting the liquid crystal in the gap between the TFT substrate 1a and the CF substrate 1b. On the other hand, the liquid crystal drop fill method is the method of dropping a prescribed amount of liquid crystal 5 in one of the TFT substrate and the CF substrate, lapping these substrate one over the other, and pasting them. This is the method of assembling the liquid crystal display panel 9 and injecting the liquid crystal 5 at a time.

Normally, a gap between the TFT substrate 1a and the CF substrate 1b, both of which compose the liquid crystal display panel 9, is as narrow as 3 to 5 μm. Hence, for completely filling the liquid crystal 5 in the gap of 3 to 5 μm through the liquid crystal drop fill method, it is necessary to vacuum the space of the liquid crystal display panel using a vacuum chamber, put the liquid crystal in contact with the liquid crystal inlet of the display panel, and inject the liquid crystal through the effect of the capillary action and a pressure difference between the inside and the outside of the liquid crystal display panel. For this method, however, the operations of vacuuming the space of 3 to 5 μm and injecting the liquid crystal need a quite long time. In particular, with enlargement of the liquid crystal display panel and narrowing of a gap between the substrates, it is assumed that the time taken in injecting the liquid crystal becomes increasingly long. Further, it is also necessary to seal the inlet after the injecting operation is finished. Under these conditions, the operation of injecting the liquid crystal has been a factor of increasing the manufacturing cost.

On the other hand, the liquid crystal drop fill method does not need the operation of vacuuming, that is, decompressing the space of 3 to 5 μm between the TFT substrate 1a and the CF substrate 1b, both of which compose the liquid crystal display panel 9. Further, this method does not need the operation of sealing the liquid crystal inlet as well. Moreover, the time taken in filling the liquid crystal becomes shorter. Hence, this liquid crystal drop fill method may reduce the time taken in filling the liquid crystal in the display panel more than the liquid crystal injecting method.

Hereafter, the description will be oriented to the manufacture using the liquid crystal injecting method or the liquid crystal drop fill method.

The manufacture using the liquid crystal injecting method comprises the following steps.

(1) Coat a sealing material so as to surround the liquid crystal display area and form an opening (liquid crystal inlet) to which the liquid crystal is to be injected on the surrounding coat.

(2) Disperse spacers so as to keep the gap of 3 to 5 μm between the substrates. In the case of using one or both substrates with the spacers contained therein, no spacer dispersion is necessary.

(3) Position both of the substrates and paste them.

(4) Radiate ultraviolet rays or heating the substrates according to the type of the sealing material, for hardening the sealing material.

The foregoing operations complete the liquid crystal display panel with an empty space between the pair of substrates.

Then,

(5) In the case of forming multi liquid crystal panels from a large substrate, cut the substrate to each panel size.

(6) Put the liquid crystal display panel in the vacuum chamber for injecting the liquid crystal in the gap between the pair of substrates pasted therewith.

Then, decompress the space inside of the liquid crystal display panel by decompressing the vacuum chamber.

(7) Put the liquid crystal in contact with the liquid crystal inlet of the display panel and raise the pressure inside the vacuum chamber to the atmosphere or more.

As a result, the liquid crystal is injected through the effect of the capillary action and the pressure difference between the inside and the outside of the liquid crystal display panel.

(8) After wiping the liquid crystal adhering to the liquid crystal inlet, the liquid crystal inlet is sealed using the ultraviolet rays hardening resin or the like.

Next, the liquid crystal drop fill method will be described with reference to FIGS. 2A to 2E. FIGS. 2A to 2E are conceptual views for describing the method of manufacturing the liquid crystal display panel through the use of the liquid crystal drop fill method. FIGS. 2A to 2E illustrate four liquid crystal display panels 9, each of which is shown in FIG. 1, from the large substrate.

The manufacture using the liquid crystal drip fill method comprises the following steps.

(1) Disperse spacers 4 (see FIG. 1) so as to keep the interval of 3 to 5 μm between the pair of substrates 1a and 1b. In the case of using one or both substrates with the spacers contained therein, no spacer dispersion is necessary.

(2) Coat a sealing material 7 like a frame so as to surround the display area of both or one of the substrates (in FIGS. 2A to 2E, the substrate 1b) through the use of a dispenser (see FIG. 2A). Before or after coating the sealing material 7, coat a sealing material 70 for fixing two large substrates, from which four display panels are cut, on the outside of the sealing material 7 during the manufacture through the use of the same dispenser.

(3) Drop a prescribed amount of liquid crystal 5 in the inside of the sealing material 7 (see FIG. 2B).

(4) After positioning the pair of substrates 1a and 1b with each other, paste the substrates in the decomposed atmosphere (see FIG. 2C).

(5) Take the pasted substrates out to the atmosphere. Then, for hardening the sealing material 7, use a ultraviolet lamp 18 to apply ultraviolet rays to the sealing material according to the hardening condition of the sealing material 7 or heat the substrate 1 (see FIG. 2D).

(6) In the case of manufacturing a plurality of liquid crystal display panels 9 from the large substrate 1 at a batch, cut out the large substrate 1 to the panel size (see FIG. 2E).

The foregoing operations complete the liquid crystal display panel 9.

The foregoing liquid crystal drop fill method has been proposed in JP-A-62-89025 (publication 1), for example. For this liquid crystal drop fill method, it is not necessary to vacuum the space of 3 to 5 μm between the pair of pasted substrates. Further. No operation of sealing the liquid crystal inlet is required as well. Moreover, since the fill of the liquid crystal is fast, this drop fill method may reduce the time taken in filling the liquid crystal in the liquid crystal display panel more than the liquid crystal injecting method.

However, the liquid crystal drop fill method has a disadvantage that the bonding strength between the sealing material and the pair of substrates is made lower and the sealing material may be out of proper form, because the liquid crystal comes into contact with the still unhardened sealing material. Further, the contact between the unhardened sealing material and the liquid crystal makes the liquid crystal contaminated, which may lead to causing a display failure.

For preventing the contact between this unhardened sealing material and the liquid crystal, it is just necessary to use the sealing material with no liquid crystal contamination. Further, as a measure for the product structure and the manufacturing process, the method has been proposed of locating frame-like walls between the liquid crystal and the sealing material for preventing the contact of the unhardened sealing material with the liquid crystal. The method has been disclosed in JP-A-63-98630 (publication 2), JP-A-6-194615 (publication 3), and JP-A-11-38424 (publication 4).

### SUMMARY OF THE INVENTION

FIGS. 3A to 3D, FIGS. 4A and 4B, and FIG. 5 are conceptual views for describing the fluidization of the liquid crystal in the liquid crystal drop fill. In FIGS. 3A to 3D, the plan views are shown on the upper side, while the section cut on the arrow A to A of each plan is shown on the lower side. In FIGS. 4A and 4B, the plan views are shown on the right side, while the section cut on the arrow A to A of each plan is shown on the left side. Likewise, in FIG. 5, the plan views are shown on the right side, while the section cut on the A to A of each plan is shown on the left side. In the case of manufacturing the liquid crystal display panel through the use of the foregoing liquid crystal drop fill method and the relevant patent disclosed in JP-A-62-89025 (publication 1), when lapping the substrates one over the other and filling the liquid crystal in the gap, the liquid crystal 5 dropped on the substrate is spread concentrically with the dropped spot as a center as indicated in FIG. 3A to FIG. 3B to FIG. 3C to FIG. 3D. At a time, the interval between the pair of substrates 1a and 1b is made narrower to the predetermined interval regulated by the spacers 4.

As described above, the liquid crystal 5 is spreading concentrically with the dropped spot as the center (shown in a dotted line). As shown in FIG. 4A, therefore, when the liquid crystal 5 is not completely filled on the liquid crystal display panel 9 and a gap between the substrates 1a and 1b does not reach the predetermined gap, there appears a portion 12 where the liquid crystal 5 comes into contact with the sealing material 7. When the liquid crystal 5 is filled in the overall surface of the liquid crystal display panel 9, as shown in FIG. 4B, finally, the gap between the pair of substrates 1a and 1b is made narrower and thereby the width of the sealing material 7 is made wider. In this case, the sealing material 7 hit over the portion where the liquid crystal 5 comes into contact with the substrates 1a and 1b (see a portion 11 of FIG. 4B), which brings about a disadvantage that the bonding strength between the sealing material 7 of this portion and the pair of substrates 1a and 1b is made lower.

Further, for preventing the liquid crystal contamination caused by the sealing material 7, the method disclosed in the foregoing publication 1 or 3 takes the steps of locating frame-like walls 8 inside the sealing material and outside the liquid crystal display area and separating the unhardened sealing material from the liquid crystal or hardening the sealing material before the liquid crystal comes into contact with the sealing material. However, in the case of manufacturing the liquid crystal display panel through the use of the liquid crystal drop fill method, the liquid crystal is quantitatively dropped so that the gap between the pair of substrates may reach the predetermined gap regulated by the spacers, that is, the gap may have the same height as the wall 8 when the dropped liquid crystal is spread on the overall surface of the liquid crystal display panel. Hence, before and immediately after the pair of substrates 1a and 1b are lapped one over the other, as shown in FIG. 5, the liquid crystal 5 is higher than the wall 8 (h<H), so that the substrate 1a does not adhere to the wall 8. Hence, the liquid crystal 5 is overflowed from the space between the walls 8 and the opposed substrate 1b so that the unhardened sealing material 7 may come into contact with the liquid crystal 5 in the contacting portion 12. This may bring about the display failure caused by the liquid crystal contamination.

It is an object of the present invention to provide a liquid crystal display panel which is arranged to overcome the foregoing disadvantages of the prior art.

It is a further object of the present invention to provide a liquid crystal display panel which is manufactured using the liquid crystal drop fill method and composed to suppress a shortage of the bonding strength between the sealing material and the substrate and the degraded form of the sealing material caused by the contact of the sealing material with the substrate surface with which the liquid crystal is once contacted, for suppressing occurrence of a display failure.

It is another object of the present invention to provide a liquid crystal display device which is manufactured using the liquid crystal drop fill method and to suppress contamination of the liquid crystal caused by the contact of the liquid crystal with the sealing material with which the pair of substrates are pasted by controlling the fluidization of the dropped liquid crystal.

In carrying out the foregoing objects, according to an aspect of the invention, the liquid crystal display panel includes a pair of substrates between which liquid crystal is laid, a frame-like sealing portion formed of a sealing material, and walls (fluid control walls) located inside the sealing portion. It is preferable to locate the fluid control walls closer to the liquid crystal dropped spot.

By locating the fluid control walls closer to the liquid crystal dropped spot, it is possible to control the concentric spread of the liquid crystal with the dropped spot as the center in the pasting process after coating the liquid crystal so that the liquid crystal may be spread not circularly but squarely. This makes it possible to raise the filling factor of the liquid crystal and to control the period when the liquid crystal comes into contact with the sealing portion to be substantially constant until the gap between the pair of substrates comes closer to the predetermined cell gap regulated by the spacers without depending on the distance between the sealing portion and the liquid crystal dropped spot. As a result, the degraded form of the sealing portion and the variety of the bonding strength may be suppressed.

Preferably, the walls located on the substrate may be formed by coating or printing a photo-sensitive resin or ceramics on one or both of the substrates and applying the photolithography to the printed substrate, or directly coating or printing such a material.

According to another aspect of the invention, the liquid crystal display panel includes a pair of substrates between which the liquid crystal is laid, a frame-like sealing portion formed of the sealing material on the pair of substrates, and fluid control walls, the fluid control walls being located in a threefold or more frame-like manner or in a threefold or more substantially frame-like manner with partially gaps therebetween.

By locating the fluid control walls in a threefold or more frame-like or substantially frame-like manner, in the process of pasting the substrates after the liquid crystal is coated, the liquid crystal being hit over one fluid control wall may be stopped for a fixed interval of time in the space between the fluid control wall and the adjacent wall. This makes it possible to suppress the liquid crystal contamination caused by the unhardened sealing material. Preferably, the fluid control walls formed as above are located between the sealing portion and the display area and at regular gaps or formed in the so-called labyrinth structure.

According to another aspect of the invention, the liquid crystal display panel includes a pair of substrates with which the liquid crystal is laid, a frame-like sealing portion formed of a sealing material on the pair of substrates, a frame-like fluid control wall located closer to the liquid crystal dropped spot inside the sealing portion and between the sealing portion and the display area.

As described above, locating the fluid control wall closer to the liquid crystal dropped spot, inside the sealing portion, and outside the liquid crystal display area, in the pasting process after coating the liquid crystal, the function of the fluid control wall located closer to the liquid crystal dropped spot makes it possible to control the concentric spread of the liquid crystal with the dropped spot as the center and to change the spreading form of the liquid crystal from a circle into a square. This results in raising the filling factor of the liquid crystal and retarding the contact of the liquid crystal with the frame-like fluid control walls located inside the sealing portion and outside the liquid crystal display area until the gap between the pair of substrates comes closer to the predetermined cell gap regulated by the spacers. As a result, the frame-like or substantially frame-like fluid control walls located inside the sealing portion serve to sop the fluidization of the liquid crystal for a fixed time, thereby suppressing the liquid crystal contamination caused by the unhardened sealing portion.

It goes without saying that the present invention is not limited to the foregoing composition or the below-mentioned embodiments and may be modified into various forms without departing from the spirit of the invention.

### BRIEF DESCRIPTION OF THE DRAWINGS

FIG. 1 is a sectional model view for explaining a schematic structure of one liquid crystal display panel;

FIGS. 2A to 2E are conceptual views for explaining a method of manufacturing a liquid crystal display panel using a liquid crystal drop fill method;

FIGS. 3A to 3D are conceptual views for explaining fluidization of a liquid crystal in the liquid crystal drop fill method;

FIGS. 4A and 4B are conceptual views for explaining fluidization of a liquid crystal in the liquid crystal drop fill method;

FIG. 5 is a conceptual view for explaining fluidization of a liquid crystal in the liquid crystal drop fill method;

FIGS. 6A to 6C are explanatory views showing a liquid crystal display panel according to a first embodiment of the present invention;

FIGS. 7A to 7D are explanatory views showing a process of manufacturing fluid control walls;

FIGS. 8A to 8D are explanatory views showing the effect of the fluid control walls in the first embodiment of the present invention;

FIGS. 9A and 9B are explanatory views showing the effect of the fluid control walls in the second embodiment of the present invention;

FIGS. 10A to 10E are sections for explaining the location of the fluid control walls;

FIGS. 11A to 11D are explanatory views showing the exemplary forms of the fluid control walls;

FIG. 12 is a conceptual view for explaining the effect of the fluid control walls;

FIG. 13 is a conceptual view for explaining the effect of the fluid control walls;

FIG. 14 is a conceptual view for explaining the effect of the fluid control walls;

FIG. 15 is an explanatory view showing the location of the fluid control walls;

FIG. 16 is an explanatory view showing a width of the fluid control wall;

FIGS. 17A to 17C are explanatory views showing a liquid crystal display panel according to a third embodiment of the present invention;

FIGS. 18A to 18C are explanatory views showing the effect of the liquid crystal display panel according to the embodiment of the present invention;

FIG. 19 is a plan view for explaining a liquid crystal display panel according to a fourth embodiment of the present invention; and

FIGS. 20A and 20B are explanatory views showing a liquid crystal display panel according to a fifth embodiment of the present invention.

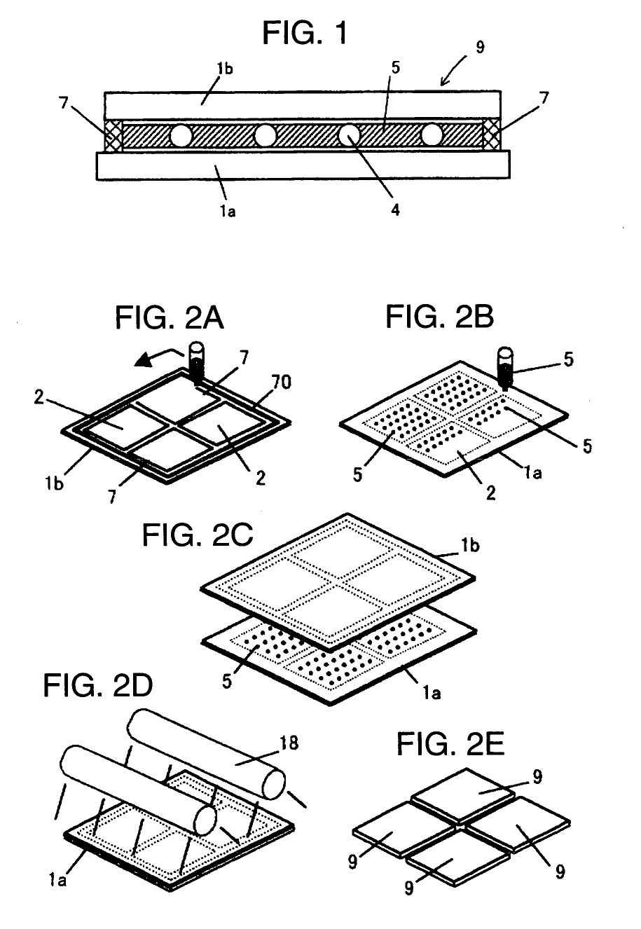

### DETAILED DESCRIPTION OF THE EMBODIMENTS

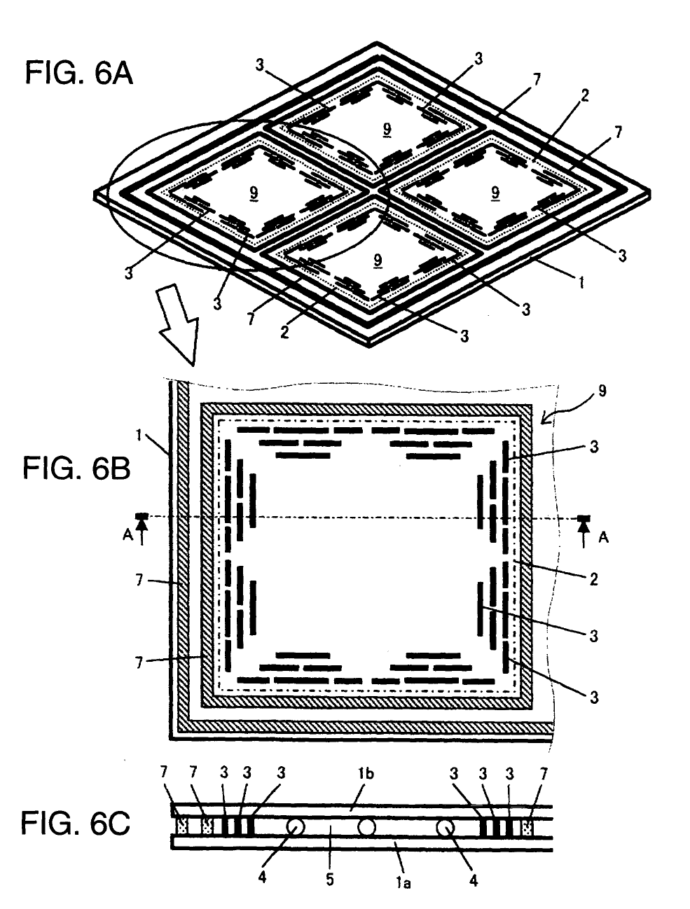

Hereafter, the embodiments of the liquid crystal display panel will be described in detail with reference to the appended drawings. FIGS. 6A to 6C are explanatory views showing the liquid crystal display panel according to a first embodiment of the present invention. FIG. 6A is a perspective view showing a large TFT substrate 1 from which four panels are cut. FIG. 6B is an enlarged plan view showing one liquid crystal display panel shown in FIG. 6A. FIG. 6C is a section cut on the A to A line of FIG. 6B.

FIG. 6A shows a locational relation among each of four liquid crystal display panels 9, a display area 2 of each panel, a sealing material 7 of each panel, and a fluid control wall 3 of each panel. As shown in FIG. 6C, each panel 9 includes a combination of a TFT substrate 1a and a CF substrate 1b and a liquid crystal 5 laid therebetween. In the display area 2 are formed spacers 4 for regulating the gap between the pair of substrates 1a and 1b and threefold frame-like fluid control walls 3. On the outer periphery of the walls 3 is attached a sealing material 7 formed in the frame-like manner. The sealing material 7 on the outmost periphery is formed for pasting the large substrate 1.

This embodiment is characterized in the use of a large substrate 1, which includes fluid control walls 3 pre-formed for controlling a fluid speed of the liquid crystal 5 inside or/and outside the display area of the TFT substrate or the CF substrate in which formed are a transparent electrode and a TFT circuit required for driving the liquid crystal 5. In the case of manufacturing the liquid crystal display 9 using the liquid crystal drop fill method, the liquid crystal is dropped on any one of the large substrate from which the TFT substrates are cut and the other large substrate from which the CF substrates are cut. In this embodiment, the liquid crystal 5 is dropped onto the side of the large substrate 1 for the TFT substrates. Then, the other large substrate (for the CF substrates) is pasted on the former large substrate in the decompressing atmosphere. This process makes it possible to fill the liquid crystal 5 onto the overall surface of the large substrate and to assemble the liquid crystal display panel 9 at a time.

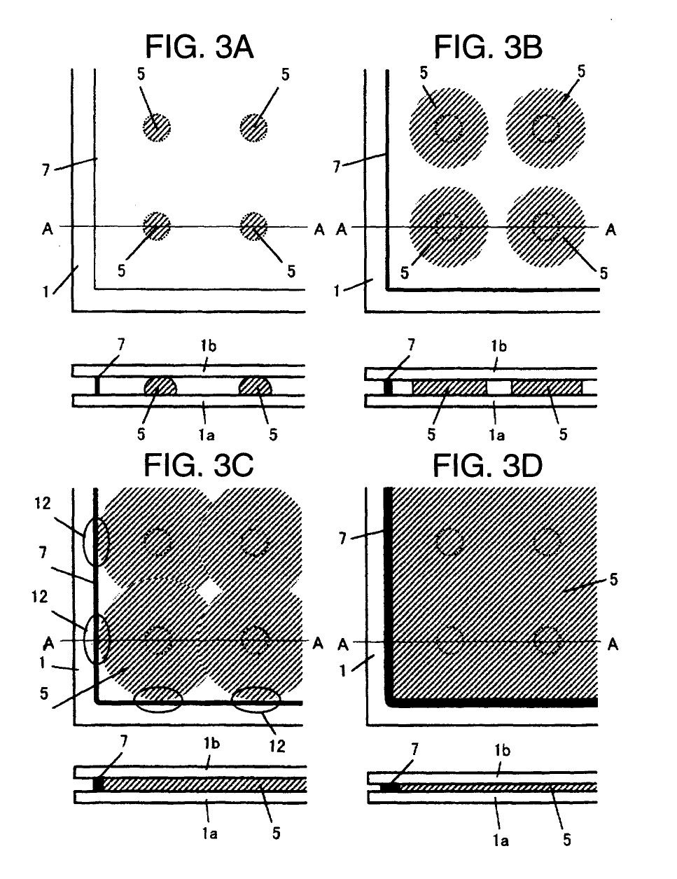

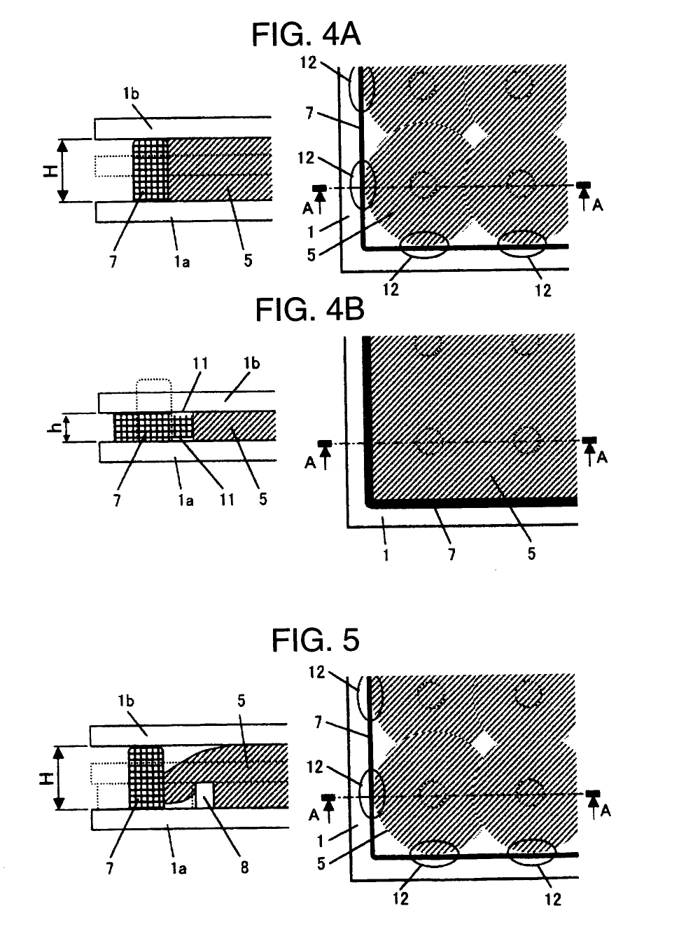

In the process of matching the gap (called a cell gap) between two large substrates lapped one over the other to the predetermined size regulated by the spacers 4 and filling the liquid crystal 5 in the liquid crystal display area 2, the liquid crystal is spread concentrically with the dropped spot as its center as shown in FIG. 3. Hence, in the process of filling the liquid crystal in the cell gap, at a portion 12, the sealing portion 7 comes into contact with the liquid crystal 5. In this case, since the interval between the pair of substrates does not still reach a predetermined distance, the dropped liquid crystal 5 is spread on the overall surface of the display panel 9 as the filling is advanced. Finally, the gap between the two substrates is made narrower as shown in FIG. 4B, so that the width of the sealing material 7 is made wider.

In this case, the sealing material is hit over the portion where the liquid crystal 5 comes into contact with the two substrates (see a portion 11 of FIG. 4B). This brings about a disadvantage of lowering the bonding strength between the sealing material 7 and the two substrates at this portion 11. Hence, it is necessary to use the substrate 1 with the fluid control walls 3 formed on one side or both sides not so as to avoid the contact between the sealing material 7 and the liquid crystal 5 in the way of filling the liquid crystal until the gap between the two substrates reaches the predetermined gap regulated by the spacers 4 by controlling the fluid of the liquid crystal 5 spread concentrically.

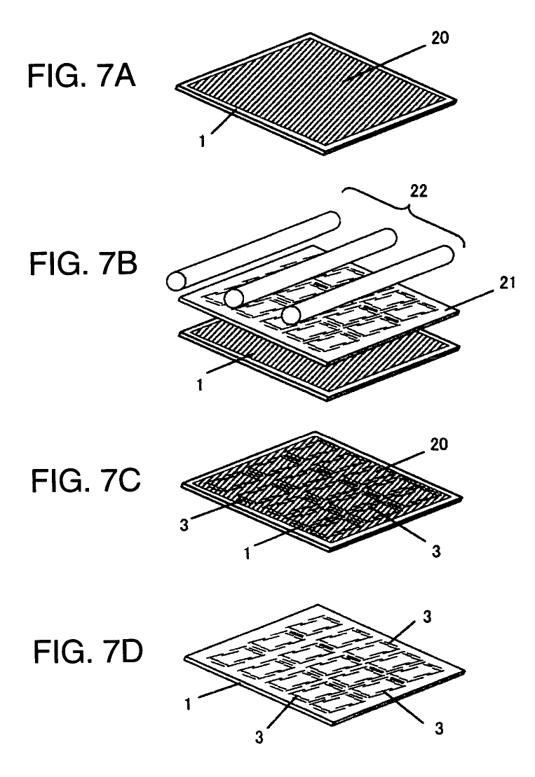

In turn, the description will be oriented to the manufacture of the fluid control walls 3 with reference to FIGS. 7A to 7D. FIGS. 7A to 7D are explanatory views for illustrating the process of manufacturing the fluid control walls. In FIGS. 7A to 7D, at first, a photosensitive resin 20 is coated on the substrate 1 by the spin coating method, the slit coating method, or the printing method so that the resin 1 may have a predetermined thickness (see FIG. 7A). Next, a photo mask 21 is used so that the fluid control walls 3 may appear convexly on the substrate 1. With the photo mask 21, the photosensitive resin 20 is exposed by using the exposure light source 22 (see FIG. 7B). Afterwards, the process is executed of developing the coated substrate and removing the photosensitive resin 20 coated on the portion where no fluid control wall 3 is to be formed (see FIG. 7C). Finally, the developing solution adhering to the substrate is washed out and the substrate 1 is dried. Then, the fluid control walls 3 are completed convexly on the substrate 1.

Alternatively, a method has been proposed of directly coating the photosensitive resin 3 or the thermosetting resin on the substrate by using the printing method or the dispensing method so that the fluid control wall 3 may be formed convexly and then performing a predetermined treatment for hardening the convex portion.

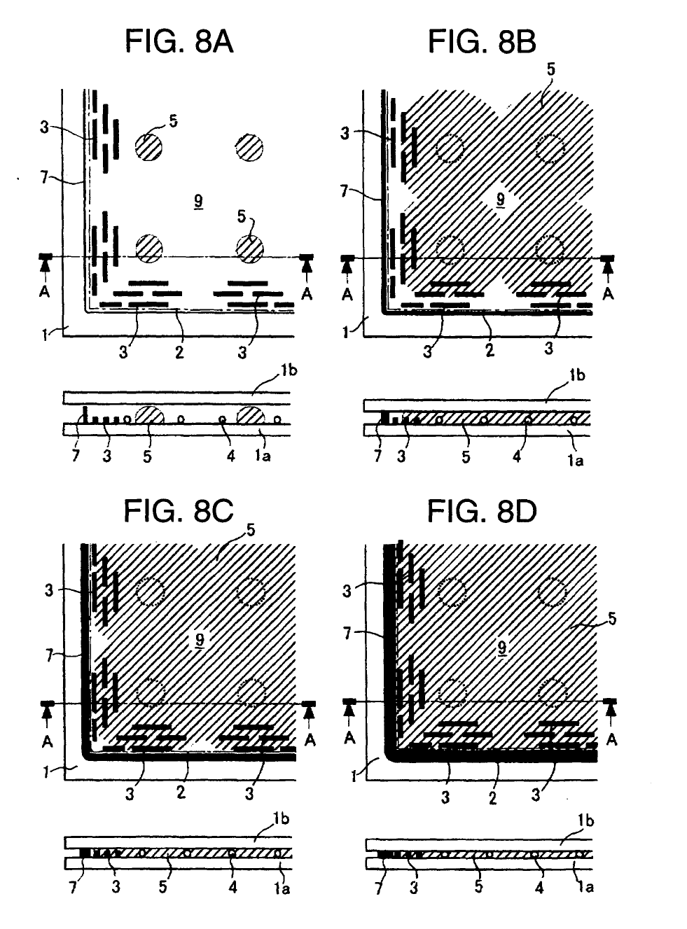

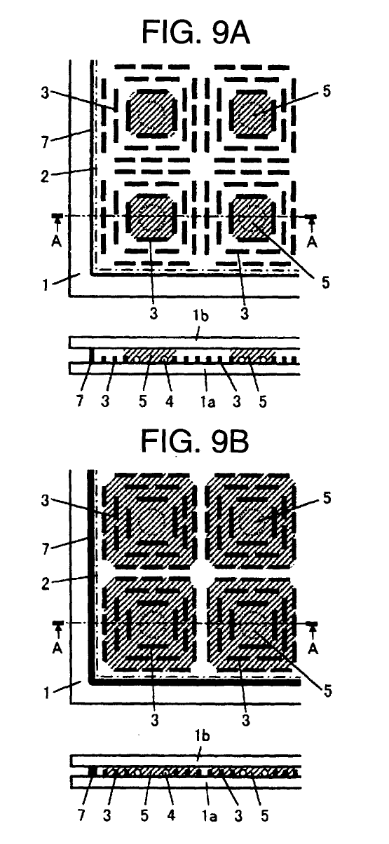

In turn, the description will be oriented to the effect of the fluid control walls 3 in the case of manufacturing the liquid crystal display panel from the substrate of this embodiment with reference to FIGS. 8A to 8D and 9A and 9B. FIGS. 8A to 8D are views for explaining the effect of the fluid control walls in the first embodiment of the present invention. In the upper side of FIGS. 8A to 8D, the plan views are shown. In the lower side thereof, the sections cut on the A-A lines of the plan views are shown. Further, FIGS. 9A and 9B are views for explaining the effect of the fluid control walls in the first embodiment of the present invention. In the upper side of FIGS. 9A and 9B, the plan views are shown. In the lower side thereof, the sections cut on the A-A lines of the plan views are shown.

On one large substrate 1 with the fluid control walls 3 formed thereon, the sealing material 7 is coated outside the liquid crystal display panel and the spacers 4 are dispersed on the substrate 1. The sealing material 7 serves to bond the two substrates with each other and suppress leakage of the liquid crystal material. The spacers 4 serve to keep the gap between the substrates constant in assembling the liquid crystal display panel. Then, the liquid crystal 5 is dropped on one of the large substrates (herein, which corresponds to the TFT substrate denoted by a numeral 1a). The total amount of the drop of the liquid crystal 5 is equivalent to the volume of the space defined by the insides of the two substrates and the sealing material 7. Preferably, the total amount of the liquid crystal 5 is divided into several drops. The liquid crystal may be dropped onto any one of the substrate with the fluid control walls 3 formed thereon and the other substrate with no fluid control walls 3.

Then, in the decompressing atmosphere, the substrate 1a where the liquid crystal 5 is dropped is exactly lapped on the other substrate 1b (see FIG. 8A). The lapped substrates 1a and 1b may be pressurized. When the substrate 1a is lapped on the other substrate 1b, the liquid crystal 5 is likely to spread concentrically (see FIG. 8B). However, the fluid control walls 3 are served as the resistance to the flow of the liquid crystal and thus the fluid speed of the portions where the walls are formed is slower than that of the other portions where no wall is formed. Hence, by locating the fluid control walls 3 with the liquid crystal dropped spots as the center, the liquid crystal 5 is spread not concentrically but rectangularly (see FIGS. 8C and 8D).

The provision of the fluid control walls 3 serves to prevent the contact between the liquid crystal 5 and the sealing material 7 caused as a result of spreading the liquid crystal 5 over the liquid crystal display panel 9 immediately until the gap between the two substrates 1a and 1b reaches the predetermined cell gap regulated by the spacers 4. This makes it possible to reduce into a minimum the amount of the sealing material 7 hit over the portion where the substrates 1a and 1b are contacted with the liquid crystal 5, which leads to solving the problem of lowering the bonding strength between the sealing material 7 and the two substrates 1a and 1b.

The foregoing description has concerned with the coat of the sealing material 7 on the substrate 1a where the liquid crystal is dropped. The sealing material 7 may be coated on the opposite substrate 1b. Instead, the sealing material 7 may be coated on both of the substrates. Further, the foregoing description has concerned with the coat of the spacers 7 on the substrate where the liquid crystal is dropped as well. The spacers 7 may be coated on the opposite substrate 1b or both of the substrates 1a and 1b. The spacers may be spherical or columnar. Like the fluid control walls, the spacers may be pre-formed on the substrate by using the photosensitive resin or the like.

As shown in FIGS. 6A to 6C and 8A to 8D, the fluid control walls 3 may be located to control only the fluid of the liquid crystal 5 coming closer to the periphery of the sealing material 7 or control the peripheral fluid (four sides of each display panel in FIGS. 9A and 9B) of the dropped liquid crystal as shown in FIGS. 9A and 9B which illustrate the second embodiment of the present invention. Further, the foregoing description has concerned with the rectangular (or square) spread of the liquid crystal 5 by the effect of the fluid control walls 3. The object of locating the fluid control walls 3 according to this embodiment is to control the fluid of the liquid crystal 5 and prevent the contact between the sealing material 7 and the liquid crystal 5 caused until the interval between the two substrates reaches the predetermined interval prescribed by the spacers 4. Hence, location of the fluid control walls 3 is not required in a manner that the spread form of the liquid crystal 5 may be rectangular. It is just necessary to locate the fluid control walls 3 as being modeled by the installing form of the sealing material.

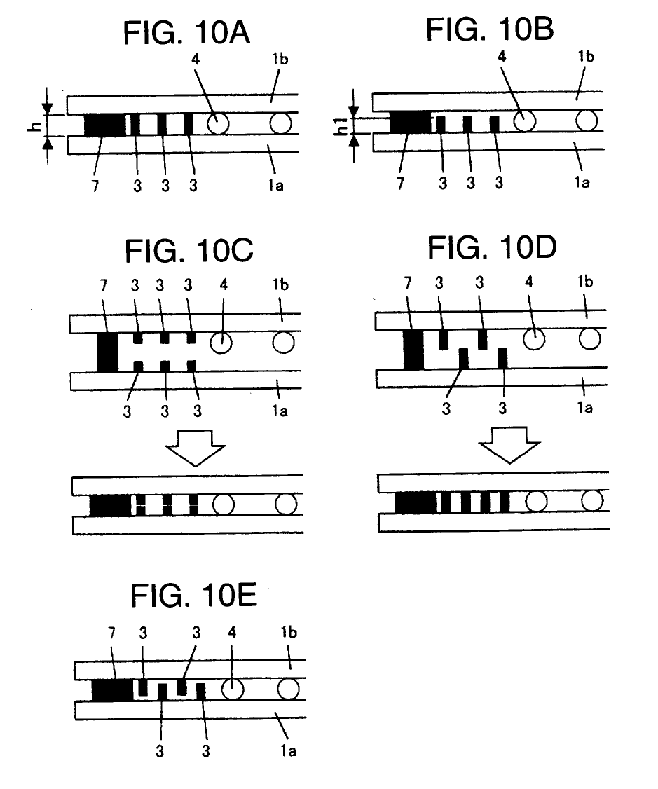

FIGS. 10A to 10E are sections for explaining where the fluid control walls are located. If the walls are located to control the fluid of the liquid crystal, the height h1 of the fluid control walls 3 may be adjusted to be equal to the height of the cell gap h after the liquid crystal display panel is assembled as shown in FIG. 10A. Further, as shown in FIG. 10B, the height h1 may be adjusted to be lower than the cell gap h. Moreover, the fluid control walls 3 may be formed on both of the two substrates 1a and 1b. The fluid control walls 3 formed on one substrate 1a may be matched in position to those formed on the other substrate 1b in lapping them as shown in FIG. 10C. Or, the former walls 3 may be mismatched in position to the latter walls 3, that is, the walls 3 may be arranged in a labyrinth structure. The height of the fluid control walls 3 may be equal to the height of the cell gap h after the substrates are assembled as shown in FIG. 10D or may be lower than the height of the cell gap h thereafter as shown in FIG. 10E.

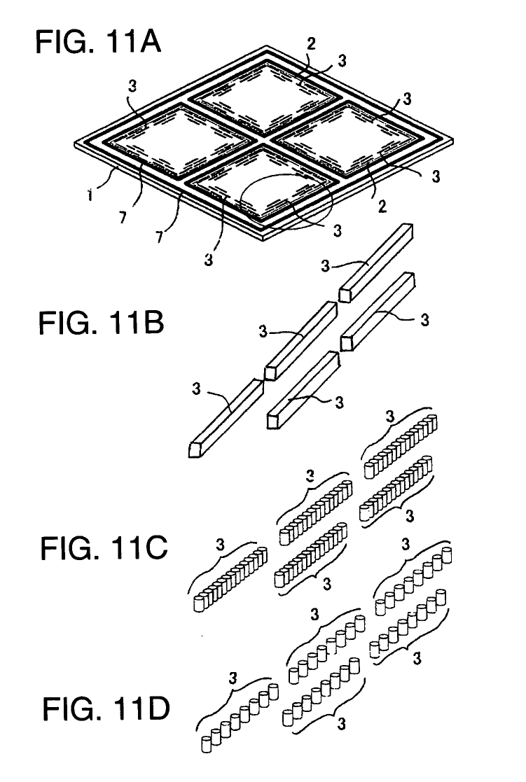

FIGS. 11A to 11D are explanatory views showing the exemplary forms of the fluid control wall. The fluid control walls 3 may be composed of prismatic walls as shown in FIG. 10A, the closely arrangement of columnar walls or conic walls as shown in FIG. 11B, or the arrangement of the columnar walls or the conic walls with intervals therebetween as shown in FIG. 11C. In this case, the combinations of the columnar or conic fluid control walls may be arranged at regular or irregular intervals. It goes without saying that the fluid control walls 3 may be provided with the same function as the spacers for keeping the interval between the two substrates constant when assembling the substrates.

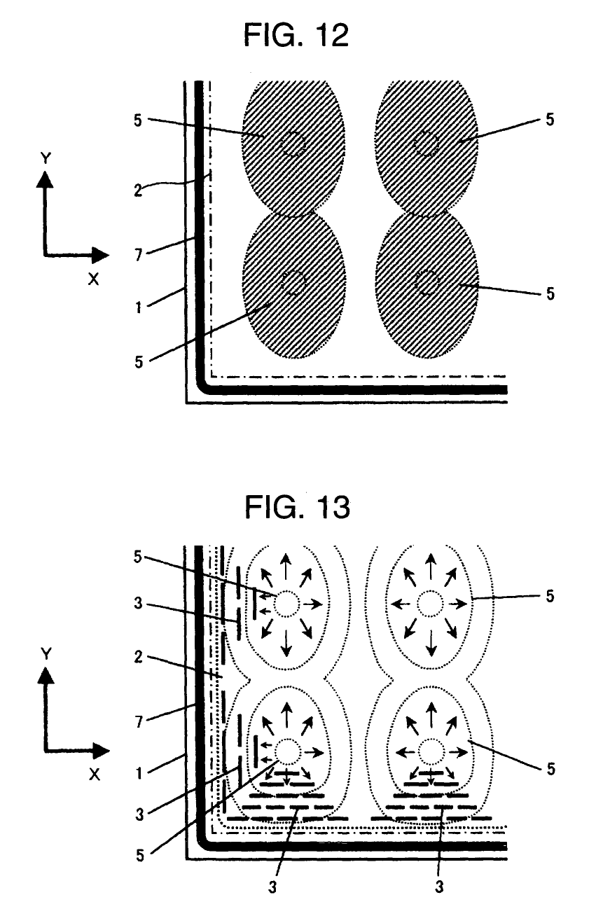

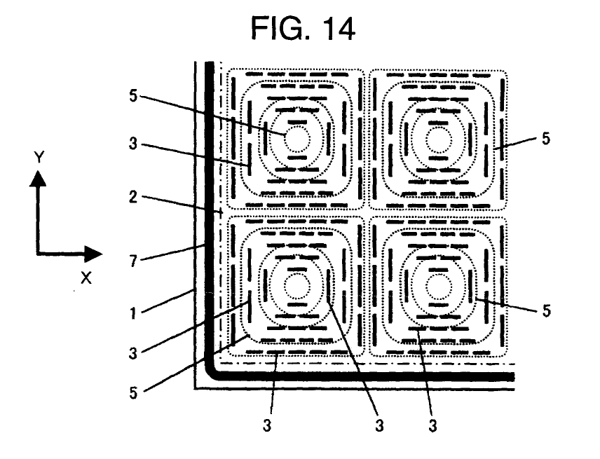

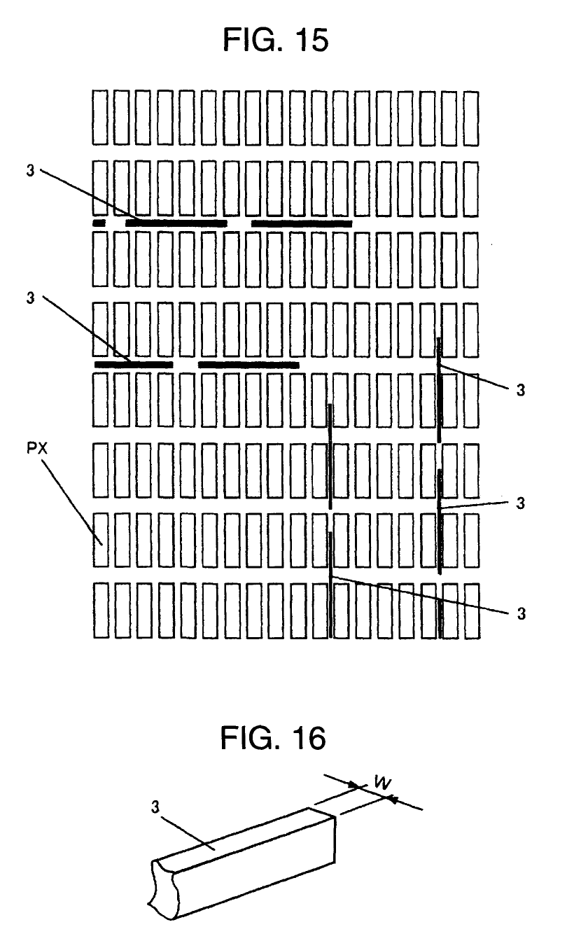

FIG. 12 is a conceptual view for explaining the fluidization of the liquid crystal. FIGS. 13 and 14 are conceptual views for explaining the effect of the fluid control walls. FIG. 15 is an explanatory view showing the location of the fluid control walls. The fluid speed of the dropped liquid crystal may be made variable according to the difference of the dropping direction caused by the conditions such as a wire step of the TFT substrate contacting with the liquid crystal 5, the patterns of the CF substrate, the printing state of the oriented film, the rubbing state, and so forth. FIG. 12 shows the case in which the fluid speed in the Y direction is faster than that in the X direction and the dropped liquid crystal is spread elliptically depending on the foregoing condition. If the fluid speed in the X direction is different from the speed in the Y direction, the liquid crystal fluid control walls 3 for controlling the fluid speed of the liquid crystal may be arranged so that the walls in the X direction are located differently from the walls in the Y direction, that is, more walls are located in the direction of the faster fluid speed. This makes it possible to increase the fluid resistance and thereby more easily control the fluid.

FIG. 13 shows the location of the liquid crystal fluid control walls 3 for controlling only the fluid of the liquid crystal 5 coming closer to the periphery of the sealing portion (which means no fluid control in the center of the display panel). FIG. 14 shows the location of the liquid crystal fluid control walls 3 for controlling the fluid of the peripheral liquid crystal 5 (four sides in FIG. 14) dropped on the substrate. In a case that the liquid crystal fluid control walls 3 are located on the display area of the liquid crystal display panel, it is preferable to locate those walls 3 between the patterns of pixels PX as shown in FIG. 15. Normally, this is for the purpose of preventing a numerical aperture of the liquid crystal panel. Further, it is necessary to make the width of each wall 3 located between the pixel patterns smaller than the interval between the pixels. FIG. 16 is an explanatory view showing the width of the liquid crystal fluid control wall. Preferably, the width of the wall 3 should be in the range of 10 to 50 μm.

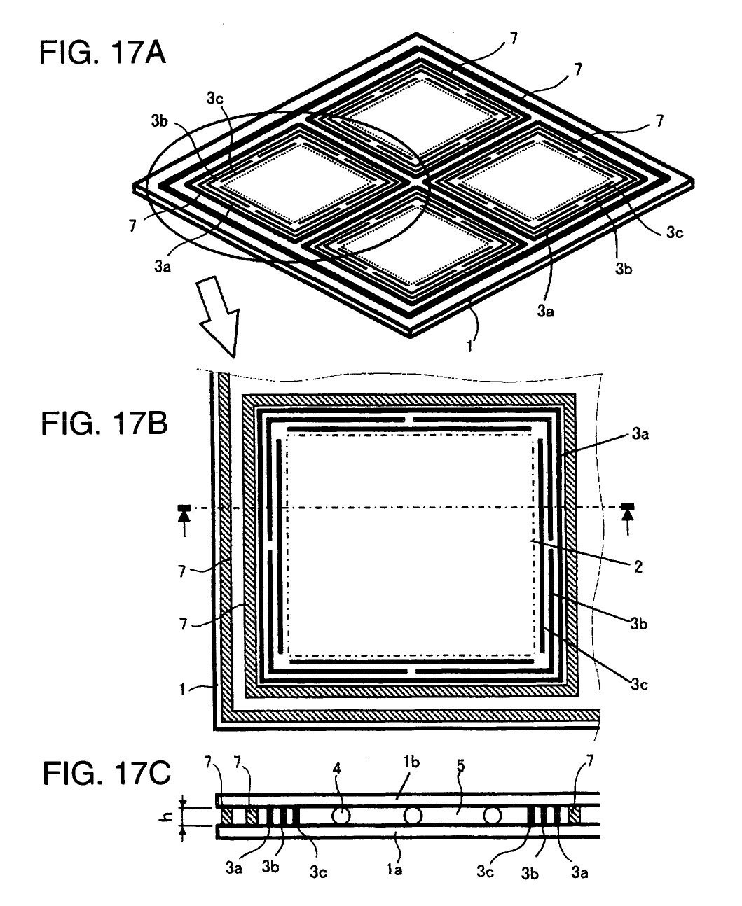

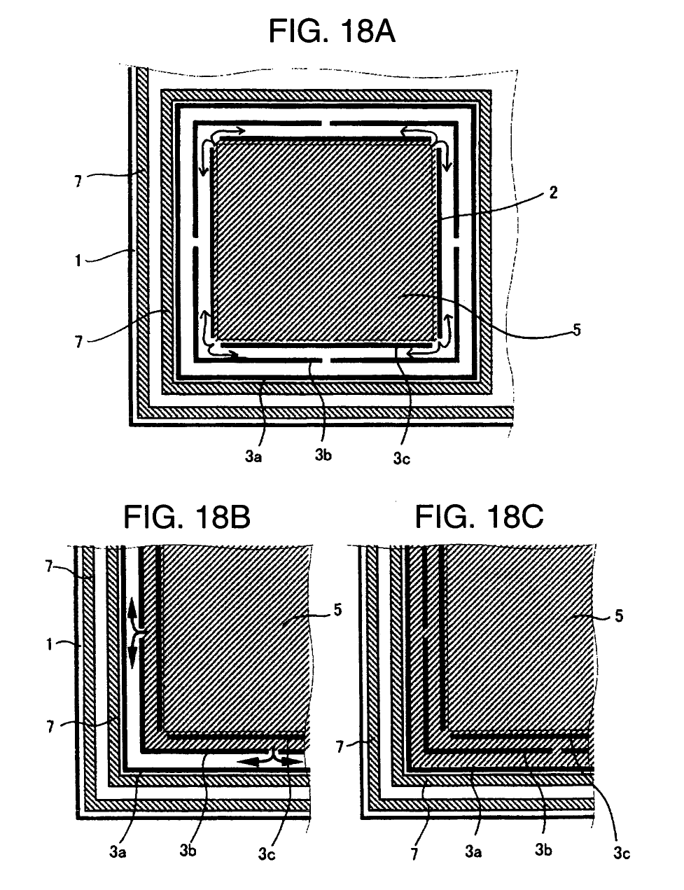

In the case of manufacturing the display panel using the liquid crystal drop fill method, the further disadvantage is also brought about. That is, before completely hardening the sealing material, the liquid crystal is contaminated by contacting the liquid crystal with the sealing material. The contamination may bring about the display failure. For preventing the liquid crystal contaminated by the contact of the unhardened liquid crystal with the sealing material, it is better to prevent the contact of the liquid crystal with the sealing material until the fluid of the liquid crystal is controlled by the frame-like wall formed to surround the display area and the sealing material is hardened. The third embodiment of the present invention will be described with reference to FIGS. 17A to 17C.

FIGS. 17A to 17C are explanatory views showing the liquid crystal display panel according to the third embodiment of the present invention. FIG. 17A is a perspective view showing the TFT substrate from which four liquid crystal display panels are cut. FIG. 17B is an enlarged plan view showing one liquid crystal display panel shown in FIG. 17A. FIG. 17C is a section cut on the A-A line of FIG. 17B. FIG. 17C shows the TFT substrate 1a being lapped on the other substrate, that is, the CF substrate 1b. FIGS. 18A to 18C are explanatory views showing the effect of the liquid crystal display panel according to the third embodiment of the present invention. FIG. 18A is an enlarged plan view showing one liquid crystal display panel as shown in FIG. 17B. FIGS. 18B and 18C are enlarged views showing a corner portion of FIG. 18A. In FIGS. 17A to 17C, the substrate on which the liquid crystal is dropped is denoted as the substrate 1.

In this embodiment, as shown in FIGS. 17A to 17C, the frame-like first fluid control wall 3a is formed inside of the sealing material 7 coated to surround the display area 2 and outside of the display area 2. It is preferable to form the first fluid control wall 3a convexly and disallow the first fluid control wall 3a to comes into contact with the sealing material 7 but to locate the wall 3a as close to the sealing material 7 as possible. Further, the second fluid control wall 3b is located inside the first fluid control wall 3a and the third fluid control wall 3c is located inside the second fluid control wall 3b. Preferably, the interval between the walls 3a and 3b or the walls 3b and 3c should be about 2.5 mm. Of course, the other interval may offer the same effect. Hence, the interval size is not limited to this value.

The first fluid control wall 3a is rectangularly formed with no slits. The second fluid control wall 3b includes a slit at a half position of each side. The third fluid control wall 3c includes a slit at each corner. In this embodiment, the width between the walls 3a and 3b or the walls 3b and 3c is 45 μm and the slit is 30 μm. Now, the description will be oriented to the fluid process of the liquid crystal in the case of manufacturing the liquid crystal display panel from the substrate of this embodiment using the liquid crystal drop fill method.

At first, the process is executed to drop the liquid crystal 5 corresponding to the volume of the space defined by the insides of the two substrates and the sealing material 7. The liquid crystal 5 is divisionally dropped several times. Then, in the decompressing atmosphere, the substrate 1a where the liquid crystal 5 is dropped is positionally lapped on the other substrate 1b. At this time, pressure may be applied to the two substrates so that the gap between these substrates may reach the predetermined interval h regulated by the spacers 4. After the substrate 1a is lapped on the other substrate 1b, the liquid crystal 5 dropped onto the substrate 1a is gradually spread on the overall surface of the substrate. In the first stage, the spread liquid crystal 5 reaches the third fluid control wall 3 (see FIG. 18A).

The liquid crystal 5 is spread along the fluid control wall 3c and on the overall surface of the substrate. Then, the liquid crystal 5 is overflowed from the slit formed in each corner and then spread to the outer periphery of the substrate 1. The liquid crystal 5 overflowed from the slit formed in the corner of the third fluid control wall 3c reaches the second fluid control wall 3b. Then, it is spread along the second fluid control wall 3b and to the outer periphery of the panel (see FIG. 18B). In the second fluid control wall 3b, the slit is formed in the center of each side. Hence, the liquid crystal 5 is flowed out of the slit formed in the second fluid control wall 3b and then is spread further to the outer periphery of the substrate. The liquid crystal 5 overflowed out of the slits of the second fluid control wall 3b reaches the first fluid control wall 3a and then is spread along the first fluid control wall 3a and on the overall surface of the panel.

As shown in FIG. 18C, when the liquid crystal 5 is sufficiently filled inside the first fluid control wall 3a, the sealing material 7 is hardened. It is preferable that the sealing material used for the liquid crystal drop fill method is a ultraviolet curing type or a ultraviolet and/or thermal curing type. For hardening the sealing material 7 at this time, the ultraviolet rays are radiated to the sealing material 7. This serves to prevent the contact between the unhardened sealing material 7 and the liquid crystal 5 and thus a display failure caused by the liquid crystal contamination. Since no slit is formed in the first fluid control wall 3a, no liquid crystal is filled between the sealing material 7 and the first fluid control wall 3a. However, by heating the assembled panel for the purpose of main hardening of the sealing material 7 and stabilizing the cell gap between the substrates 1a and 1b, the liquid crystal 5 is expanded so that a slight slit may be formed between the substrate and the first fluid control wall 3a. The liquid crystal 5 is overflowed out of this slit and then is filled between the sealing material 7 and the first fluid control wall 3a.

The dropped liquid crystal 5 is pre-calculated so as to match to the volume of the space defined by the gap between the two substrates 1a and 1b and the sealing material 7. Hence, when cooling down the liquid crystal display panel, the liquid crystal is completely filled in the space between the two substrates, so that the liquid crystal display panel may have a predetermined cell gap.

The foregoing embodiment has a structure wherein as the gap of the second fluid control wall 3, one slit from which the liquid crystal is overflowed is formed in the center of each side. If the fluid control effect of the liquid crystal may be obtained, two or more slits may be formed on each side. Further, this embodiment also has a structure wherein the slit of the second fluid control wall 3b is located in the center of each frame side and the slit of the third fluid control wall 3c is located in the corner of each frame side. In place, the slit of the second fluid control wall 3b is located in the corner of each frame side and the slit of the third fluid control wall 3c is located in the center of each frame side. In the foregoing embodiment, therefore, the slits of the second fluid control wall 3b are positionally shifted from the slits of the third fluid control wall 3c. If the fluid control effect of the liquid crystal may be obtained, the slits of the second fluid control wall 3b may be positionally matched to those of the third fluid control wall 3c. Moreover, though the three kinds of fluid control walls 3 are provided in the foregoing embodiment, the same effect may be obtained by more kinds of walls.

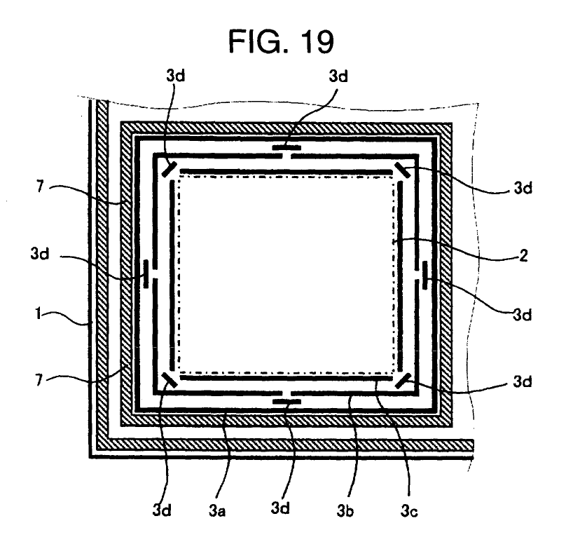

FIG. 19 is the similar plan view as FIG. 18A for describing the liquid crystal display panel according to the fourth embodiment of the present invention. In this embodiment, as shown in FIG. 19, another fluid control wall 3d is formed as opposed to and closer to each slit of the second and the third fluid control walls 3b and 3c. The fluid control wall 3d serves to block the liquid crystal overflowed out of each slit. This fluid control wall 3d has a function of suppressing the flow of the liquid crystal overflowed out of the slits formed in the second and the third fluid control walls 3b and 3c, in particular, the concentric spread of the liquid crystal 5 with the dropped spot as the center and orienting the spread of the liquid crystal in the substantially same form as the location of the sealing material 7. This embodiment may offer the same effect as the foregoing embodiment.

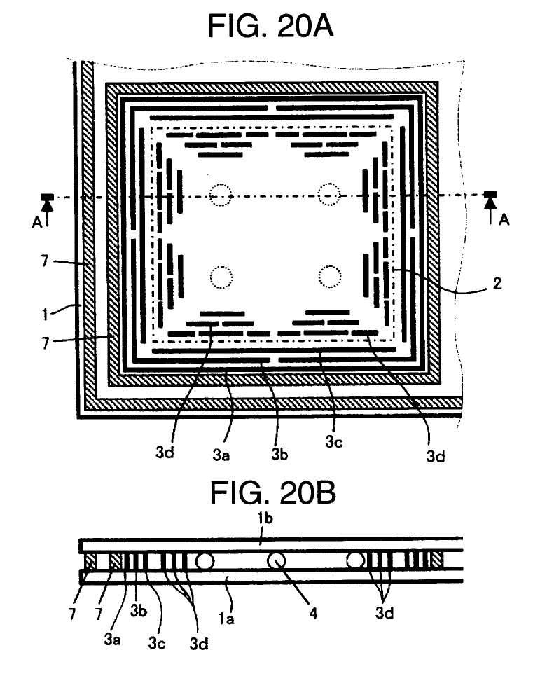

FIGS. 20A and 20B are explanatory views showing the liquid crystal display panel according to a fifth embodiment of the present invention. FIG. 20A is the same plan view as FIG. 19. FIG. 20A is a section cut on the A-A line of FIG. 20A. As shown in FIGS. 20A and 20B, another fluid control wall 3d is located closer to the liquid crystal dropped spot indicated by a dotted circle. Further, frame-like walls 3a, 3b and 3c are located between the sealing material 7 and the display area 2. The other fluid control walls 3d located closer to the liquid crystal dropped spot serve to suppress the concentric spread of the liquid crystal 5 with the dropped spot as the center. According to this embodiment, as described above, the spread form of the liquid crystal 5 is made to be not circular but square as being modeled by the square sealing material 7. This is effective in raising the filling factor of the liquid crystal 5 and more greatly retarding the contact of the liquid crystal 5 with the frame-like wall 8 located inside the sealing material 7 and outside the display area until the interval between the two substrates comes closer to the predetermined cell gap.

As set forth above, according to the present invention, the fluid control walls are located closer to the liquid crystal dropped spot. These walls serve to resist the flow of the liquid crystal, thereby lowering the fluid speed of the liquid crystal. Based on this principle, the present invention makes it possible to control the concentric spread of the liquid crystal with its dropped spot as the center, make the spreading form of the liquid crystal not circular but square as being modeled by the square sealing material. This is effective in raising the filling factor of the liquid crystal and keep the period of the contact of the liquid crystal with the sealing portion substantially constant irrespective of the distance between the sealing material and the liquid crystal dropped spot, until the gap between the two substrates comes closer to the predetermined cell gap regulated by the spacers. This effect suppresses the form failure and the variety of the bonding strength of the sealing material.

Moreover, by locating the frame-like sealing material formed on one pair of substrates and threefold or more frame-like fluid control walls inside the sealing material, in the process of pasting the substrates after coating the liquid crystal, it is possible to resist the liquid crystal overflowed out of first walls in the interval between the fluid control walls and the adjacent fluid control walls for a fixed time, thereby suppressing the contamination of the liquid crystal by the still unhardenend sealing material and preventing the display failure caused by the liquid crystal contamination.

Further, the fluid control walls are located closer to the liquid crystal dropped spot and the other frame-like fluid control walls are also located between the sealing material and the display area. The fluid control walls located closer to the liquid crystal dropped spot serve to control the concentric spread of the liquid crystal with its dropped spot as the center in the pasting process after coating the liquid crystal and thereby to make the spreading form of the liquid crystal not circular but rectangular (square) as being modeled by the sealing material. This function makes it possible to raise the filling factor of the liquid crystal and to retard the contact of the liquid crystal with the frame-like walls located inside the sealing material and outside the display area until the gap between the two substrates comes closer to the predetermined cell gap. This results in offering the high-quality liquid crystal display panel which is arranged to improve the effect of resisting the fluid of the liquid crystal through the frame-like fluid control walls located inside the sealing material for a fixed length of time and thereby suppressing the liquid crystal contaminated by the unhardened sealing material and preventing the display failure caused by the liquid crystal contamination.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A liquid crystal display panel comprising:
a pair of substrates lapped one over the other;
a liquid crystal material laid between said pair of substrates and forming a display area, and wherein
said pair of substrates includes a sealing portion formed of a sealing material and fluid control walls located inside said sealing portion.

2. A liquid crystal display panel according to claim 1, wherein said fluid control walls are located inside said sealing portion and on said display area.

3. A liquid crystal display panel according to claim 1, wherein said fluid control walls are located inside said sealing portion and outside said display area.

4. A liquid crystal display panel according to claim 1, wherein said fluid control walls are located inside said sealing portion and inside and outside said display area.

5. A liquid crystal display panel according to claim 1, wherein said fluid control walls are located threefold or more inside said sealing portion and outside said display area.

6. A liquid crystal display panel according to claim 5, wherein one or more slits are formed in one or more parts of said fluid control walls rather than the outermost peripheral wall.

7. A liquid crystal display panel according to claim 1, wherein said fluid control walls are located on any one of said pair of substrates.

8. A liquid crystal display panel according to claim 1, wherein said fluid control walls are located on each of said pair of substrates.

9. A liquid crystal display panel according to claim 8, wherein said fluid control walls located on one of said pair of substrates are positionally matched to said fluid control walls located on the other substrate when said pair of substrates are lapped one over the other.

10. A liquid crystal display panel according to claim 8, wherein said fluid control walls located on one of said pair of substrates are not positionally matched to said fluid control walls located on the other substrate when said pair of substrates are assembled, and said fluid control walls located on each of said substrates are arranged in a labyrinth structure.

11. A liquid crystal display panel according to claim 1, further comprising:
spacers for regulating a gap between said pair of substrates, laid between said pair of substrates, and wherein
each of said fluid control walls has the same height as the gap between said pair of substrates when said pair of substrates are lapped one over the other or as said spacers.

12. A liquid crystal display panel according to claim 1, further comprising:
spacers for regulating a gap between said pair of substrates when said pair of substrates are lapped one over the other, laid between said substrates, and wherein
each of said fluid control walls has a smaller height than the gap between said pair of substrates when said substrates are assembled or than said spacers.

13. A liquid crystal display panel according to claim 1, further comprising:
spacers for regulating a gap between said pair of substrates when said substrates are lapped one over the other, laid between said pair of substrates, and wherein
said fluid control walls are provided with the same function as said spacers when assembling said substrates.
